(19) United States
(12) Patent Application Publication
(10) Pub. No.: US 2008/0199502 A1
(43) Pub. Date: Aug. 21, 2008

(54) Antimicrobial Solution Comprising a Metallic Salt and a Surfactant

(76) Inventors: Dominic Tessier, Longueuil (CA); Martin Filteau, Candiac (CA); Ion Radu, Montreal (CA)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/910,637

(22) PCT Filed: Apr. 7, 2006
(86) PCT No.: PCT/CA2006/000543

§ 371 Date: Apr. 25, 2008

Related U.S. Application Data
(60) Provisional application No. 60/669,348, filed on Apr. 8, 2005.

(51) Int. Cl. A01N 25/02; A01N 59/16; A01P 1/00

(52) U.S. Cl. 424/405; 424/618

(57) ABSTRACT

The present invention concerns solutions having an antimicrobial activity. The solutions described herein comprise particles containing slightly soluble metallic salt and surfactant. In the solutions described herein, the molar ratio between the slightly soluble metallic salt and the surfactant is lower than or equal to about 1. Also described are substrates comprising the solutions, methods for producing substrate comprising the solutions, methods for producing the solutions and uses of the solutions for substrate finishing and substrate sanitization.

### TECHNICAL FIELD

This invention relates to solutions having antimicrobial activity as well as methods for producing the same. The inventions also relates to substrates comprising the solutions as well as methods for producing the same. The solutions described herein can also be used for substrate finishing and substrate sanitizing.

### BACKGROUND OF THE INVENTION

Many commercial liquid antibacterial and antimicrobial solutions have been developed for fabric finishing operations. These solutions may be applied either in padding or exhaust/dyeing processes. Durability to washing of the antimicrobial treatment will depend on many parameters such as the leachability of the antimicrobial compound, the aqueous solubility of the antimicrobial compound (or its K_{SP} value), the type of fibres, the concentration used and the application method. Antimicrobial solutions that can be applied in fabric finishing operations include, for example, Ultrafresh™ (Thomson research associates, Canada) Sanitized™ (Sanitized, AG Switzerland/Clariant), Biosil™ (Toyobo, Japan), Peach Fresh™ (Nisshinbo, Japan) and Sanitan™ (Kuray, Japan).

Other antimicrobial technologies, based on polymer-grafted N-halamines or polymer-grafted quaternary ammonium compounds or QAC (e.g. aromatic quaternary ammonium salt monomer forming the corresponding polymers) claim to be durable and refreshable by bleaching or washing, thus providing a sanitizing effect. Nevertheless, the antimicrobial activity of these compounds lasts for a very limited period of time.

Some antimicrobial after-wash liquid formulations have also been proposed. Among such antimicrobial products, chlorine bleach, a well-known disinfectant, is widely used as laundry disinfectant; however, antimicrobial properties do not remain after drying. Other after-wash liquid formulations have been developed by Ecolab Inc. (U.S. Pat. No. 6,593,283 issued on Jul. 15, 2003, U.S. Pat. No. 6,391,925 issued on May 21, 2002), a collaboration between Ecolab Inc, DiverseyLever, and Procter & Gamble (AdvaCare™ Sanitizer/Sour and AdvaCare™ 120 system), the Regents of the University of California (U.S. Pat. No. 5,882,357 issued on Mar. 16, 1999; U.S. Pat. No. 6,436,419 issued on Aug. 20, 2002), Vanson Halosource Inc. (WO 03/106466 published Dec. 24, 2003; WO 03/095431 published Nov. 20, 2003; WO 02/30477 published Apr. 18, 2002), DiverseyLever (a laundry sanitizer which uses a sanitizing bleach compound) and Procter & Gamble (U.S. Pat. No. 6,465,410 issued on Oct. 15, 2002; U.S. Pat. No. 6,451,333 issued on Sep. 17, 2002; WO 99/03512 published on Jan. 29, 1999).

Other technologies have been developed wherein a composition is applied to a textile (e.g. fabric finishing). Such technologies have been developed by Aegis Environmental Man (WO 03/062345 published 2003), Clariant GmbH (U.S. Pat. No. 6,376,696 issued on Apr. 23, 2002), Procter & Gamble (WO 02/16535 published on Feb. 28, 2002; U.S. patent application 2004/0127463 published Jul. 1, 2004) and Zeneca Ltd. (U.S. Pat. No. 5,700,742 issued on Dec. 23, 1997).

Antimicrobial water-based solutions available nowadays differ in composition. Quaternary ammonium compounds such as alkylammonium halogenides and chlorinated organic compounds such as chlorinated phenols, among others, have been used in antimicrobial water-based solutions. However, the quaternary ammonium compounds and chlorinated organic compounds have showed to be efficient against only a limited variety of bacteria while not providing evidence for efficiency against viruses. Moreover, such compounds may not confer an efficient control of antimicrobial pathogens over time because they are soluble in water and may be consumed rapidly or leached by water. Therefore, sustained and durable control or various antimicrobial pathogens is not possible with these compounds.

Antibacterial and antimicrobial silver fabrics have been developed with silver compounds. Silvers compounds may be extruded with a thermoplastic polymer, or dispersed in a wet-spun polymer composition, in a manner to obtain a fibre with antimicrobial activity. Silver compounds may be applied either as a coating in a wet process or by physical deposition technologies. Antimicrobial silver fabrics have also been prepared by introducing silver fibres in the fabric structure itself. Antimicrobial silver fabrics have been described, for example, in the following documents: US 2003/176827-2003, WO 03/053484, U.S. Pat. No. 6,584,668, WO 01/94687, U.S. Pat. No. 6,669,966, U.S. Pat. No. 5,985,308, U.S. Pat. No. 6,017,553, U.S. Pat. No. 6,080,490, U.S. Pat. No. 6,238,686, U.S. Pat. No. 6,333,093, U.S. Pat. No. 4,728,323, U.S. Pat. No. 6,087,549, U.S. Pat. No. 6,348,423, U.S. Pat. No. 6,166,084, U.S. Pat. No. 5,925,009, CA 2,343,440, U.S. Pat. No. 6,605,751, U.S. Pat. No. 6,355,858, U.S. Pat. No. 5,928,174, U.S. Pat. No. 6,468,521, U.S. Pat. No. 6,726,791, U.S. Pat. No. 6,669,981 and U.S. Pat. No. 6,716,895.

Metallic silver, silver oxides, and silver salts are known to have antimicrobial properties; unfortunately, slow-release systems of very slightly soluble metals, such as nanocrystalline metallic silver, do not confer a large zone of inhibition or a high microbial killing rate because of limited availability of silver ions in such metallic systems. Therefore, it is highly desirable to obtain antimicrobial fabrics which possess high antibacterial activity while maintaining wide-range biocidal properties.

Only a few fabrics have been developed with copper and commercialized for their antimicrobial properties. These fabrics are said to possess antiviral properties, thus providing biological protection against both viruses and bacteria. Examples of such fabrics are described in DE 60102291D, WO 01/74166, WO 00/75415, CA 2,407,087, WO 01/81671 and U.S. Pat. No. 6,482,424.

It would be advantageous to use a combination of different antimicrobial compounds and/or chemicals. Such combination may provide a synergistic antimicrobial effect therefore providing an improved antimicrobial activity. More recently, several systems propose the introduction of antimicrobial metallic nanoparticles into aqueous solutions. However, the nanoparticles tend to be unstable and coalescence/coagulation problems have been observed. Furthermore, metallic nanoparticles in these solutions have the propensity to form deposits that cannot or hardly be re-dispersed.

Thus, there has been a growing interest to have an antimicrobial water based solutions for application to various needs comprised in infection prevention and/or control. The prevention or control of infectious diseases find much of importance in medical, wound dressings, healthcare (including disposables), personal care products, biopharmaceutical, veterinary, military and bio-defence, protective clothing, household goods, laundry, food, filtration, and cosmetic market sectors.

It would be highly desirable to be provided with an antimicrobial composition that is active against all microbial pathogens such as viruses, bacteria, yeasts, fungi, molds and microbial-derived toxins. It would also be highly desirable to be provided with an antimicrobial composition that comprises more than one antimicrobial compound. It would further be desirable to be provided with an antimicrobial composition comprising a stable colloidal solution of metallic ions. It would also be highly desirable to be provided with an antimicrobial composition that is heat-resistant and possesses a long lasting antimicrobial effect. It would also be highly desirable to be provided with an antimicrobial composition that can be safely applied in direct contact with the human skin or a wound. It would also be desirable to be provided with an antimicrobial composition that does not cause irritation, allergic reaction or poisoning.

### SUMMARY OF THE INVENTION

The present invention relates to solutions having antimicrobial activity, substrates comprising the solutions, methods of producing the solution and uses of the solutions.

In a first aspect, the present invention provides a solution having an antimicrobial activity, the solution comprises particles having at least one slightly soluble metallic salt and at least one surfactant and wherein the molar ratio between the slightly soluble metallic salt and the surfactant is lower than or equal to about 1. In an embodiment, the molar ratio between the slightly soluble metallic salt and the surfactant is lower than or equal to about 0.8; in another embodiment, lower than or equal to about 0.6. In a further embodiment, the average size of the particles is of about 10 nm to about 1000 nm; in another embodiment, of about 10 nm to about 500 nm; in yet another embodiment, of about 10 nm to about 150 nm; in still another embodiment, of about 100 nm to about 150 nm and in still a further embodiment, of about 160 nm to about 170 nm. In an embodiment, the antimicrobial activity is against a microorganism selected from the group consisting of a bacterium, a fungus, and a virus. In yet another embodiment, the antimicrobial activity is against a bacterium. In still yet another embodiment, the bacterium is selected from the group consisting of Staphylococcus aureus, Bacillus cereus, Escherichia coli, Shigella sp., Salmonella sp. and Listeria monocytogenes. In an embodiment, the antimicrobial activity is against a fungus. In another embodiment, the fungus is selected from the group consisting of Aspergillus niger, Chaetomium globosum, Penicillium funiculosum, Aureobasidium pullulans, Trichoderma virens and Candida albicans. In an embodiment, the concentration of the slightly soluble metallic salt in the solution is of about 4×10⁻⁴ M to about 2 M; in another embodiment, of about 0.02 M to about 0.04 M, and still in another embodiment, is of about 0.04 M. In yet another embodiment, the slightly soluble metallic salt is selected from the group consisting of a slightly soluble copper salt, a slightly soluble silver salt and a slightly soluble gold salt. In a further embodiment, the slightly soluble metallic salt is a slightly soluble copper salt. In an embodiment, the slightly soluble copper salt is selected from the group consisting of copper (I) chloride, copper (I) bromide, copper (I) iodide, copper (I) fluoride, copper perchlorate, copper (II) iodate, copper sulphate and copper methosulphate. In an embodiment, the slightly soluble metallic salt is a slightly soluble silver salt. In another embodiment, the slightly soluble silver salt is selected from the group consisting of silver (I) chloride, silver (I) bromide, silver (I) iodide, silver perchlorate, silver sulphate and silver methosulphate. In yet another embodiment, the slightly soluble metallic salt is a slightly soluble gold salt. In still another embodiment, the slightly soluble gold salt is selected from the group consisting of gold (I) chloride, gold (I) bromide, gold (I) iodide, gold perchlorate, gold sulphate and gold methosulphate. In an embodiment, the slightly soluble metallic salt is a slightly soluble metallic halide, in another embodiment, the slightly soluble metallic halide is silver chloride. In an embodiment, the concentration of the surfactant in the solution is of about 1×10⁻⁴ M to about 0.5 M; in a further embodiment, of about 0.025 M to about 0.05 M; in still a further embodiment, of about 0.05 M. In an embodiment, the surfactant is a cationic surfactant. In another embodiment, the cationic surfactant is an alkylammonium halogenide. In an embodiment, the alkylammomium halogenide is alkylammonium chloride or alkylammonium bromide. In still another embodiment, the alkylammonium halogenide is selected from the group consisting of cetyl trimethyl ammonium bromide, octadecyl dimethyl benzyl ammonium bromide, N-cetyl pyridinium bromide, octylphenoxyethoxy ethyl dimethyl benzyl ammonium chloride, N-(laurylcoco-aminoformylmethyl)pyridinium chloride, lauryloxyphenyl-trimethyl ammonium chloride, dodecylbenzyl trimethyl ammonium chloride, chlorinated dodecylbenzyl trimethyl ammonium chloride, dioctyl dimethyl ammonium chloride, benzalkonium chloride, myristyl dimethylbenzyl ammonium chloride, methyl dodecyl xylene-bis-trimethyl ammonium chloride, benzethonium chloride, 2-butenyl dimethyl ammonium chloride polymer, behenalkonium chloride, cetalkonium chloride, cetarylalkonium bromide, cetylpyridinium chloride, lauralkonium bromide, lauralkonium chloride, lapyrium chloride, lauryl pyridinium chloride, myristalkonium chloride, olealkonium chloride, isostearyl ethyldimonium chloride, benzyltrimethylammonium dichloroiodate and trimethoxy silyl propyl dimethyl octaecyl ammonium chloride. In an embodiment, the alkylammonium halogenide is benzalkonium chloride. In another embodiment, the surfactant is a quaternary ammonium compound. In still another embodiment, the cationic surfactant is an alkylammonium chloride. In yet a further embodiment, the alkylammonium chloride is selected from the group consisting of (2-(4-acetylamino-benzenesulfonylamino-et)-dimethyl-undecyl-ammonium chloride; (2,6-dihydroxy-hexahydro-furo(3,2-b)furan-3-yl)-trimethyl-ammonium chloride; (2-cl-3-phenylaminomethylene-cyclohex-1-enylmethylene)-phenyl-ammonium chloride; (2-isopropyl-5-methyl-cyclohexyloxycarbonylmethyl)-trimethyl-ammonium chloride; (2-oxo-benzothiazol-3-ylmethyl)-tripopyl-ammonium chloride; (3,4-dichloro-benzyl)-dimethyl-(1-propoxycarbonyl-undecyl)-ammonium chloride; (3-dimethylamino-2-phenyl-allylidene)-dimethyl-ammonium chloride (1); 4-(4,6-diamino-M-tolyl)imino-2,5-cyclohexadien-1-ylidene)di-me-ammonium chloride; (4-allyl-2-methoxy-phenoxycarbonylmethyl)-triethyl-ammonium chloride; adamantan-1-yl-decycloxycarbonylmethyl-dimethyl-ammonium chloride; allyloxycarbonylmethyl-trimethyl-ammonium chloride; benzyl-(1-ethoxycarbonyl-undecyl)-dimethyl-ammonium chloride; benzyl-(1-hexyloxycarbonyl-undecyl)-dimethyl-ammonium chloride; benzyl-(1-methoxycarbonyl-undecyl)-dimethyl-ammonium chloride; benzyl-(2-(2-bromo-3-methyl-butyryloxy)-theyl)-methyl-ammonium chloride; benzylbis(2-hydroxymethyl)(2-dodecyloxyethyl) ammonium chloride; benzyldimethyl(2-dodecycloxyethyl)-ammonium chloride; benzyldimethyl(2-hydroxyethyl)ammonium chloride; benzyldimethyl (hexadecylcarbamoylmethyl)ammonium chloride; benzyldimethyl(tetradecylcarboamoylmethyl)ammonium chloride; benzyloxycarbonylmethyl-trimethyl-ammonium chloride; bis-(2-hydroxyethyl)-cinnamyl(2-dodecyloxyethyl)ammonium chloride; bis(triphenylphosphoranylidene)ammonium chloride; carboxymethyl-dimethyl-ammonium chloride; dimethyldodecyl(5,6,7,8-tetrahydro-2-naphthylmethyl)ammonium chloride; dimethyloctadecyl[3-(trimethoxysilyl)propyl]ammonium chloride; dodecyl-dimethyl-(3-phenyl-allyloxycarbonylmethyl)-ammonium chloride; tetrakis(2-chloroetyl)ammonium chloride; tributyl-(2-hydroxy-3-(2-oxo-benzothiazol-3-yl)-propyl)-ammonium chloride; triethyl-(2-hydroxy-3-(2-oxo-benzothiazol-3-yl)-propyl)-ammonium chloride; trimethyl-(2-oxo-benzothiazol-3-ylmethyl)-ammonium chloride; trimethyl-vinyloxycarbonylmethyl-ammonium chloride; trioctyl-(2-oxo-benzothiazol-3-ylmethyl)-ammonium chloride and tris-(2-hydroxy-ethyl)-(2-oxo-benzothiazol-3-ylmethyl)-ammonium chloride. In another embodiment, the cationic surfactant is a alkylphosphonium halogenide. In an embodiment, the alkylphosphonium halogenide is an alkylphosphonium chloride or an alkylphosphonium bromide. In yet another embodiment, the alkylphosphonium chloride is selected from the group consisting of 1-(1 h-benzoimidazol-2-yl)-2-di-me-amino-vinyl)-triphenyl-phosphonium chloride; (1,3-dioxo-1,3-dihydro-isoindol-2-ylmethyl)-triphenyl-phosphonium chloride; (1-(3-tert-butyl-ureido)-2,2-dichloro-vinyl)-triphenyl-phosphonium chloride; (1-(4-bromo-benzoylamino)-2,2-dichloro-vinyl)-triphenyl-phosphonium chloride; (1-acetylamino-2,2-dichloro-vinyl)-triphenyl-phosphonium chloride, (1-acetylamino-2-chloro-2-methylsulfanyl-vinyl)-triphenyl-phosphonium chloride (1), (1-acetylamino-2-cl-2-(4-cl-phenylsulfanyl)-vinyl)-tri-ph-phosphonium chloride; (1-acetylamino-2-oxo-2-phenyl-ethyl)-triphenyl-phosphonium chloride; (1-benzoylamino-2,2-bis-ethylsulfanyl-vinyl)-triphenyl-phosphonium chloride; (1-(benzoylamino)-2,2-bis(methylthio)vinyl)(triphenyl)phosphonium chloride; (1-benzoylamino-2,2-bis-phenylsulfanyl-vinyl)-triphenyl-phosphonium chloride; (1-benzoylamino-2,2-dichloro-vinyl)-triphenyl-phosphonium chloride; (1-benzoylamino-2-(4-chloro-phenyl)-vinyl)-triphenyl-phosphonium chloride; (1-benzoylamino-2-(4-cl-phenylsulfanyl)-vinyl)-triphenyl-phosphonium chloride; (1-benzoylamino-2-(4-nitro-phenyl)-vinyl)-triphenyl-phosphonium chloride; (1-benzoylamino-2-chloro-vinyl)-triphenyl-phosphonium chloride; (1-(benzoylamino)-2-cl-2-((4-cl-phenyl)thio)vinyl)(triphenyl)phosphonium chloride; (1-(benzoylamino)-2-cl-2-(4-fluorophenyl)vinyl)(triphenyl)phosphonium chloride; (1-benzoylamino-2-cl-2-P-tolylsulfanyl-vinyl)-triphenyl-phosphonium chloride; (1-(benzoylamino)-2-hydrazinovinyl)(triphenyl)phosphonium chloride; (1-benzoylamino-2-phenyl-vinyl)-triphenyl-phosphonium chloride; (1-benzoylamino-2-phenylsulfanyl-vinyl)-triphenyl-phosphonium chloride; 1-ethoxyyl-5,5-diphenyl-pyrazol-3-yl-triphenyl-phosphonium chloride; (1H-benzoimidazol-2-ylmethyl)-triphenyl-phosphonium chloride; (2,2-dl-cl-1-((2,4-dichlorobenzoyl)amino)vinyl)(triphenyl)phosphonium chloride; (2,2-dichloro-1-(2-chloro-acetylamino)-vinyl)-triphenyl-phosphonium chloride; (2,2-dichloro-1-(2-fluoro-aetylamino)-vinyl)-triphenyl-phosphonium chloride;(2,2-dichloro-1-(3,3-dimethyl-ureido)-vinyl)-triphenyl-phosphonium chloride; (2,2-dichloro-1-(3-phenyl-ureido)-vinyl)-triphenyl-phosphonium chloride; (2,2-dichloro-1-((4-chlorobenzoyl)amino)vinyl)(triphenyl)phosphonium chloride; (2,2-dichloro-1-(4-fluoro-benzoylamino)-vinyl)-triphenyl-phosphonium chloride; (2,2-dichloro-1-(4-methoxy-benzoylamino)-vinyl)-triphenyl-phosphonium chloride; (2,2-dichloro-1-(4-methyl-benzoylamino)-vinyl)-triphenyl-phosphonium chloride; (2,2-dichloro-1-ethoxycarbonylamino-vinyl)-triphenyl-phosphonium chloride; 2,2-dichloro-1-methoxycarbonylamino-vinyl)-triphenyl-phosphonium chloride; (2,2-dichloro-1-phenylacetylamino-vinyl)-triphenyl-phosphonium chloride; ((2,2-dimethyl-propionylamino)-methyl)-triphenyl-phosphonium chloride; (2-(4-cl-ph)-1-(5-phenyl-tetrazol-1-yl)-vinyl)-triphenyl-phosphonium chloride; (2-adamantan-1-yl-2-methoxycarbonyl-vinyl)-triphenyl-phosphonium chloride; (2-anilino-5-(4-morpholinyl)-1,3-oxazol-4-yl)(triphenyl)phosphonium chloride; (2-(benzoylamino)-2-carboxy-1-phenylvinyl)(triphenyl)phosphonium chloride; (2-benzoylamino-2-ethoxycarbonyl-1-phenyl-vinyl)-triphenyl-phosphonium chloride; (2-benzoylamino-2-ethoxycarbonyl-vinyl)-triphenyl-phosphonium chloride; (2-benzoylamino-3-oxo-3-piperidin-1-yl-propenyl)-triphenyl-phosphonium chloride; (2-carboxy-1-(4-chloro-benzoyl)-2-oxo-ethyl)-triphenyl-phosphonium chloride; (2-chloro-1-(2,2-dimethyl-propionylamino)-vinyl)-triphenyl-phosphonium chloride; (2-chloro-1-(4-chloro-benzoylamino)-vinyl)-triphenyl-phosphonium chloride; ((2-chloro-acetylamino)-methyl)-triphenyl-phosphonium chloride; (2-ho-3-(2-oxo-1,3-benzothiazol-3(2h)-yl)pr)(tri-ph)phosphonium chloride hydrate; (2-hydroxy-3-(2-oxo-benzothiazol-3-yl)-propyl)-triphenyl-phosphonium chloride; (2-methyl-5-(4-morpholinyl)-1,3-oxazol-4-yl)(triphenyl)phosphonium chloride; (2-methyl-5-(methylthio)-1,3-thiazol-4-yl)(triphenyl)phosphonium chloride; (2-((oxo-1,2-diphenyl-ethylldene)-hydrazano)-pr)-triphenyl-phosphonium chloride; (2-oxo-2-phenyl-1-phenylacetylamino-ethyl)-triphenyl-phosphonium chloride; (2-oxo-benzothiazol-3-ylmethyl)-triphenyl-phosphonium chloride; (3-benzyloxy-4-methoxy-benzyl)-triphenyl-phosphonium chloride; (3-carboxy-propyl)-methyl-diphenyl-phosphonium chloride; (3-carboxy-propyl)-triphenyl-phosphonium chloride; (3-mercapto-1-ph-pyrimido(1,6-a)benzimidazol-4-yl)(tri-ph)phosphonium chloride; ((4-chloro-benzoylamino)-methyl)-triphenyl-phosphonium chloride; (((4-chlorobenzoyl)amino)methyl)(triS(ethylamino)) phosphonium chloride (1), (4-mercapto-6-oxo-2-p-tolyl-2H-pyrimidin-5-yl)-triphenyl-phosphonium chloride; (4-methoxy-3,6-dioxo-cyclohexa-1,4-dienylmethyl)-triphenyl-phosphonium chloride; (5-amino-pyrazolo(1,5-a)pyrimidin-3-yl)-triphenyl-phosphonium chloride; (5-anilino-2-phenyl-1,3-oxazol-4-yl)(triphenyl)phosphonium chloride; (5-(benzoyl-phenyl-amino)-2-phenyl-oxazol-4-yl)-triphenyl-phosphonium chloride; (5-(benzylthio)-2-phenyl-1,3-thiazol-4-yl)(triphenyl)phosphonium chloride; (5-cyanomethylsulfanyl-2-ph-1H-imidazol-4-yl)-triphenyl-phosphonium chloride; (5-(methylamino)-2-phenyl-1,3-oxazol-4-yl)(triphenyl)phosphonium chloride; (5-methylsulfanyl-2-phenyl-1H-imidazol-4-yl)-triphenyl-phosphonium chloride; (6-(2-(chloro-me-ph)-vinyl)-pyridiN-2-ylmethyl)-triphenyl-phosphonium chloride; (((adamantan-1-carbonyl)-amino)-methyl)-triphenyl-phosphonium chloride; allyl-triphenyl-phosphonium chloride; benzyl-carboxymethyl-diphenyl-phosphonium chloride; benzyl-methyl-diphenyl-phosphonium chloride; bis-(2-cyano-ethyl)-methyl-naphthalen-1-ylmethyl-phosphonium chloride; (chloromethyl)(triphenyl)phosphonium chloride; (cl-1-(4-cl-benzoylamino)-2-ethylsulfanyl-vinyl)-triphenyl-phosphonium chloride; (eto-carbonyl-4,4-di-me-5,5-diphenyl-pyrazol-yl)-triphenyl-phosphonium chloride; phenanthren-9-ylmethyl-triphenyl-phosphonium chloride; tetrakis[tris(dimethylamino) phosphoranylidenamino]phosphonium chloride; triphenyl-((2,2,2-trichloro-acetylamino)-methyl)-phosphonium chloride; triphenyl-((2,2,2-trifluoro-acetylamino)-methyl)-phosphonium chloride; triphenyl-(2-phenyl-5-P-tolylamino-oxazol-4-yl)-phosphonium chloride; triphenyl(2-pyridylmethyl)phosphonium chloride hydrochloride; triphenyl-(3,4,5-trimethoxy-benzyl)-phosphonium chloride and triphenyl(3-pyridiNylmethyl)phosphonium chloride.

In another aspect, the present invention provides a substrate comprising the solution described herein. In an embodiment, the solution is applied as a coating on the substrate. In another embodiment, the coating comprises a binder or a polymer coating formulation. In a further embodiment, the coating is applied during a finishing operation.

In a further aspect, the present invention provides a method for producing a substrate, said method comprising contacting said substrate with the solution described herein.

In yet another aspect, the present invention provides a substrate produced by the method described herein.

In still another aspect, the present invention provides a method for producing a solution having an antimicrobial activity, the method comprises combining, in a solution, at least one soluble metallic salt and at least one surfactant, the solution comprises particles, the particles comprise at least one slightly soluble metallic salt and the surfactant, wherein the molar ratio between said slightly soluble metallic salt and said surfactant is lower than or equal to about 1. Various embodiments of the molar ratio between the slightly soluble metallic salt and the surfactant have been described above. Various embodiments of the average size of the particles have been described above. Various embodiments of the antimicrobial activity have been described above. Various embodiments of the concentration of the slightly soluble metallic salt have been described above. In an embodiment, the soluble metallic salt is selected from the group consisting of a soluble copper salt, a soluble silver salt and a soluble gold salt. In an embodiment, the soluble metallic salt is a soluble copper salt. In another embodiment, the soluble copper salt is selected from the group consisting of copper (II) nitrate, copper (II) acetate monohydrate, copper (II) chloride, copper (II) bromide, copper (II) chlorate hexahydrate, copper (II) formate, copper (II) butanoate monohydrate, copper (II) sulphate, copper (II) perchlorate and copper (II) hexafluorosilicate. In an embodiment, the soluble metallic salt is a soluble silver salt. In a further embodiment, the soluble silver salt is selected from the group consisting of silver (I) nitrate, silver (I) acetate, silver (I) chlorate, silver (I) fluoride and silver (I) perchlorate. In an embodiment, the soluble silver salt is a silver (I) nitrate. In yet another embodiment, the soluble metallic salt is a soluble gold salt. In yet another embodiment, the soluble gold salt is selected from the group consisting of gold (III) fluoride, gold (III) chloride and gold (III) bromide. Various embodiments of the slightly soluble metallic salt have been described above. Various embodiments of the concentration of the surfactant in the solution have been described above. Various embodiments of the surfactant have been described above.

In another aspect, the present invention provides a solution produced by the method described herein.

In a further aspect, the present invention provides use of the solution described herein or prepared by the method described herein for finishing a substrate.

In yet another aspect, the present invention provides use of the solution described herein or prepared by the method described herein for sanitizing a substrate.

### DETAILED DESCRIPTION OF THE PREFERRED EMBODIMENT

In accordance with the present invention, there is provided solutions having antimicrobial activity. Such solutions may be applied to substrates such as fabrics. Fabrics coated with such solutions, method of coating fabrics with the solutions and method of producing such solutions are also provided.

In a first aspect, the present invention provides a solution having an antimicrobial activity. The solution comprises particles comprising a slightly soluble metallic salt and a surfactant. For those skilled in the art, the solubility of a compound is established on a relative scale. In an embodiment, the solubility of a metallic salt is related to its K_{SP} value (Handbook of Chemistry and Physics, CRC Press, 80th Ed., 1999, Sections 4 and 8). In general, the solubility of a metallic salt is proportional to its K_{SP} value, e.g. the less soluble, the lower the K_{SP} value and vice versa. As used herein, the term “slightly soluble” refers to metallic salts having a K_{SP} value below 1×10⁻⁴. For example, the K_{SP} value of the slightly soluble silver chloride salt is 1.77×10¹⁰.

In the solutions described herein, the molar ratio between the slightly soluble metallic salt and the surfactant in the solution is between about 0.6 to about 1. In an embodiment, the molar ratio is lower than or equal to about 1, in another embodiment, lower than or equal to about 0.8, and in a further embodiment, lower than or equal to about 0.6. The molar ratio between the metallic salt and the surfactant can be calculated with the following formula:

$$Molar Ratio = \frac{M of the slightly soluble metallic salt in the solution}{M of the surfactant in the solution}$$

wherein M is the molarity of the compound

The solutions are stable over a long period of time (e.g. more than 65 hours). In an embodiment, the solutions described herein are stable over several months (e.g. more than three or more than six months) when stored in appropriate conditions (e.g. at room temperature, protected from daylight). The solutions described herein do not show coagulation or show a delayed coagulation with respect to other solutions (such as metallic nanoparticles suspensions) known in the art. As used herein, the term “coagulation” refers to the process (active or passive) of converting a finely divided or colloidally dispersed suspension of solid particles into larger particles of such size that the particles rapidly settle. When coagulation occurs, the larger solid particles are said to coalesce and/or precipitate and no redispersion of the particles can be observed. In an embodiment, the solution described herein does not show flocculation or show a delayed flocculation with respect to other solutions known in the art. As used herein, the term “flocculation” refers to the formation of larger particles of a solid phase dispersed in a solution by the gathering of smaller particles, the agglomeration of particles into groups or flocks and/or the gathering of suspended particles into aggregation. “Flocculation” also refers to a type of aggregation characteristic of finely solid particles dispersed in a liquid or semiliquid matrix. When flocculation occurs in a solution, the settled particles can be redispersed (e.g. by agitation).

The particles found in the solutions may have a zeta potential higher than 50 mV (e.g. between 50 and 70 mV, between 50 and 60 mV, between 50 and 54 mV or between 50.8 to 53.4 mV). The zeta potential (ζ) is the electric potential at the surface of a colloidal particle relative to the potential in the bulk medium at a long distance. The zeta potential is also referred to the electrokinetic potential. The zeta potential (ζ) can also refer to the potential across the interface of all solids and liquids. Specifically, the zeta potential refers to the potential across the diffuse layer of ions surrounding a charged colloidal particle, which is largely responsible for colloidal stability. The stability of hydrophobic colloids depends on the zeta potential. For example, when the absolute value of zeta potential is above 50 mV, the dispersions are very stable due to mutual electrostatic repulsion and, when the zeta potential is close to zero, the coagulation (formation of larger assemblies of particles) is very fast and this causes a fast sedimentation. Even when the surface charge density is very high but the zeta potential is low, the colloids are unstable. Also, the velocity of heterocoagulation (coagulation of different particles) depends on the zeta potentials of both kinds of particles. Therefore, the zeta potential is an important parameter characterizing colloidal dispersion. The zeta potential of a particle can be calculated if the electrophoretic mobility of the sample is known by Henry's Equation:

$$Ue = \frac{2 ɛζ f ( ka )}{3 η}$$

Where Ue is the electrophoretic mobility, ∈ is the dielectric constant of the sample, ζ is the zeta potential, f(ka) is Henry's Function (most often used are the Huckel and Smoluchowski approximations of 1 and 1.5, respectively), and η is the viscosity of the solvent. The zeta potential of a sample of colloidal particles is easily quantified using an LDV, or Laser Doppler Velocimeter. The LDV applies an electrical field of known strength across the sample, through which a laser is then passed. The electrophoretic mobility of the colloid will dictate the velocity with which the charged particles move which will then induce a frequency shift in the incident laser beam. Using either the Huckel or Smoluchowski approximation for Henry's Function, the dielectric constant of the sample, the viscosity of the solvent, and finally the measured electrophoretic mobility, the zeta potential of the particles within the colloid can be calculated.

Without wishing to be bound to any specific theory, in the solutions described herein, the slightly soluble metallic salt is stabilized by using a surfactant present in molar excess. The surfactants are taught to lower the surface energy of the slightly soluble metallic salt solution and impede coagulation and/or flocculation. Consequently, the stabilized slightly soluble metallic salt remains smaller in size than its unstabilized counterpart (e.g. slightly soluble metallic salt in a solution that does not contain any surfactant). In addition, the slightly soluble metallic salt of the present solution possesses an improved surface distribution once the solution is applied to a substrate.

In an embodiment, the solutions described herein are aqueous solutions (e.g. water-based solutions). As such, the solutions can readily be used in domestic and industrial laundering applications. In another embodiment, the solutions described herein may also contain a further solvent (such as an organic solvent, an alcohol or an acid) to suit the conditions the solutions are used (refer below).

According to an embodiment, particles (e.g. particles comprising a slightly soluble metallic salt and a surfactant) are present in the solution. The particles may be uniformly distributed in the solution. In another embodiment, the particles may be micro- or nano-particles. When the solution is applied (e.g. dipped, coated or sprayed) into/onto a substrate, the particles can be deposited to obtain a uniform surface distribution. In an embodiment, the average size of the particles is ranging from about 10 to about 1000 nm; in a further embodiment from about 10 to about 500 nm and, in yet a further embodiment from about 10 nm to about 150 nm; in a still further embodiment, from about 100 nm to about 150 nm; in still another embodiment, from about 160 nm to about 170 nm.

According to one aspect, the solutions described herein possess antimicrobial activity against various microorganisms. As used herein, the term “antimicrobial activity” is intended to mean the ability of an agent (compound, solution or composition) to halt, impede, slow down or decrease the growth of a microorganism and/or the ability of the agent to destroy or kill the microorganism. An agent with antimicrobial activity can, for example, alter/destroy the integrity of the microorganism, delay the replication of the microorganism, inhibit the availability of nutriments to the microorganism, impede the production of a toxin by the microorganism, etc. The terms “anti-microbial” and “antimicrobial” are used herein interchangeably. In an embodiment, the solutions described herein possess a wide range of antimicrobial activities (e.g. antimicrobial activity is observed against various types of microorganisms). The antimicrobial activity of the solutions may also last over a prolonged period of time. In addition or alternatively, the solutions can be coupled to a sustained, slow-release formulation. The antimicrobial activity of the solutions may also be effective against a narrower range of microorganims (e.g. limited to one type of microorganisms).

In an embodiment, the solutions described herein can serve as a microbicide or a microbiocide (e.g. an agent that kills or destroys microbes), a microbistat or microbiostat (e.g. an agent that impedes, slows down or decreases the growth of a microbe), a bactericide or a bacteriocide (e.g. an agent that kills or destroys bacteria), a bacteristat or bacteriostat (e.g. an agent that impedes, slows down or decreases the growth of bacteria), a fungicide (e.g. an agent that kills or destroys fungi and/or molds), a fungistat (e.g. an agent that impedes, slows down or decreases the growth of fungi and/or molds), a virucide (e.g. an agent that kills or destroys viruses) or a virustat (e.g. an agent that impedes, slows down or decreases the growth of viruses).

In an embodiment, the solutions described herein possess an antimicrobial activity against a microorganism selected from the group consisting of a bacterium (e.g. gram-positive and gram-negative bacteria), a fungus and a virus. As used herein, the term “microorganism” is intended to mean an organism of microscopic nature. Microorganisms include, but are not limited to, viruses, prokaryotes (such as bacteria) and eukaryotes (such as yeasts, fungi and molds). Bacteria include, but are not limited to, eubacteria and archeobacteria as well as gram positive and gram negative bacteria. Specifically, the solutions described herein may possess antimicrobial activity against Staphylococcus aureus, Bacillus cereus, Bacillus anthracis, Escherichia coli, Shigella sp., Salmonella sp., Listeria monocytogenes, Pseudomonas aeruginosa and/or Enterococcus faecium. Fungus is defined herein as a single-celled or multicellular organism without chlorophyll that reproduces by spores and lives by absorbing nutrients from organic matter. Fungi include, but are not limited to mildews, molds, mushrooms, rusts, smuts, and yeasts. Specifically, the solutions described herein may possess antimicrobial activity against Aspergillus niger, Chaetomium globosum, Penicillium funiculosum, Aureobasidium pullulans, Trichoderma virens and Candida albicans.

As mentioned above, the antimicrobial activity of the solutions may be specific for one type of microorganism, one species of microorganism, one strain of microorganism or one isolate of microorganism. Alternatively, the antimicrobial activity of the solutions may be effective against more than one type of microorganism, more than one species of microorganism, more than one strain of microorganism or more than one isolate of microorganism.

In a further embodiment, the specificity of the antimicrobial activity of the solutions may be selected for the intended use of the solution or the intended use of a substrate treated with the solution. For example, if the solution is applied onto a substrate that is used for clothing (e.g. that is in direct contact with the skin), the antimicrobial activity of the solution would preferably be effective against microorganisms normally found in the skin's micro flora (such as Staphylococcus aureus) or microorganisms that can infect the skin. On the other hand, if the solution is applied onto a substrate that is used for wound dressing (e.g. that is in direct contact with the wound and the surrounding skin), the antimicrobial activity of the solution would preferably be effective against microorganims found in the wound or that could infect the wound. If the solution is applied onto a substrate that can be used in a humid or wet environment (such as the sails of a boat), the antimicrobial activity of the solution would preferably be effective against the type of microorganims usually found in this kind of substrate (such as molds). If the solution is applied onto a substrate that can be used in food processing, the antimicrobial activity of the solution would preferably be effective against microorganims naturally occurring in the food and/or against microorganism that can replicate in the food (such as Escherichia coli Salmonella sp. and Listeria monocytogenes).

In a further embodiment, the solutions described herein can also include a further agent known for its antimicrobial activity. This further agent may improve the overall antimicrobial activity of solution. For example, this further agent may be a soluble metallic salt (referred below) or a further surfactant (such as an anionic, nonionic, zwitterionic, ampholytic and/or cationic surfactant). In an embodiment, this further agent should not compromise the stability of the particles already in the solution (e.g. should not cause or accelerate coagulation or flocculation of the particles). In a further embodiment, the use of one or more complementary antimicrobial agents combined into the solution may improve the overall biocidal, antimicrobial, antifungal and antiviral properties of the solution.

In another embodiment, the particles described herein comprise a slightly soluble metallic salt. The slightly soluble metallic salt includes, but is not limited to slightly soluble copper salts, slightly soluble silver salts, slightly soluble gold salts or a combination thereof. In another embodiment, the concentration of the slightly soluble metallic salt in the solution is of about 4×10⁻⁴ M to about 2 M. In a further embodiment, the concentration of the slightly soluble metallic salt in the solution is of about 0.02 M to about 0.04 M. In yet a further embodiment, the concentration of the slightly soluble metallic salt in the solution is of about 0.04 M.

In another embodiment, the solutions described herein may comprise a metallic colloidal solution of the slightly soluble metallic salt. The metallic colloidal solution of the slightly soluble metallic salt may contain copper ions, silver ions, gold ions or a combination thereof.

In an embodiment, the slightly soluble copper salts may be selected from the group consisting of copper (I) chloride, copper (I) bromide, copper (I) iodide, copper (I) fluoride, copper perchlorate, copper (II) iodate, copper sulphate, copper methosulphate or a mixture thereof.

In another embodiment, the slightly soluble silver salts include, but are not limited to, silver (I) chloride, silver (I) bromide, silver (I) iodide, silver perchlorate, silver sulphate, silver methosulphate or a mixture thereof.

In a further embodiment, the slightly soluble gold salts may be, for example, gold (I) chloride, gold (I) bromide, gold (I) iodide, gold perchlorate, gold sulphate, gold methosulphate or a mixture thereof.

In another embodiment, the slightly soluble metallic salt present in the particles is metallic halide such as silver chloride or silver iodide.

In an embodiment, the particles described herein comprise a surfactant. As used herein, the term “surfactant” refers to a surface active agent, an agent that, when added to a solution, modifies the properties of that solution at the surface or interface. Without wishing to be bound to any specific theory, the surfactant added to the solution stabilizes the interface between the slightly soluble metallic salt and the solution, thereby limiting flocculation and coagulation phenomena. The surfactants used in the solutions described herein are, in an embodiment, cationic surfactants. The concentration of the surfactant in the solution may be of about 1×10⁻⁴ M to about 0.5 M, of about 0.025 M to about 0.05 M or of about 0.05 M.

In an embodiment, the surfactant itself may possess antimicrobial activity. The antimicrobial activity of the surfactant may be of a broad spectrum (e.g. effective against various types, species, strains or isolates of microorganisms) or of a narrower spectrum (specific to one type, species, strain or isolate of microorganisms).

As mentioned above, in an embodiment, surfactants are cationic surfactants. The cationic surfactants may comprise two long alkyl chain. Examples of such cationic surfactants include the ammonium surfactants such as alkylammonium halogenides (e.g. alkylammonium chloride or alkylammonium bromide). Such alkylammonium halogenides include, but are not limited to cetyl trimethyl ammonium bromide, octadecyl dimethyl benzyl ammonium bromide, N-cetyl pyridinium bromide, octylphenoxyethoxy ethyl dimethyl benzyl ammonium chloride, N-(laurylcoco-aminoformylmethyl)pyridinium chloride, lauryloxyphenyl-trimethyl ammonium chloride, dodecylbenzyl trimethyl ammonium chloride, chlorinated dodecylbenzyl trimethyl ammonium chloride, dioctyl dimethyl ammonium chloride, benzalkonium chloride, myristyl dimethylbenzyl ammonium chloride, methyl dodecyl xylene-bis-trimethyl ammonium chloride, benzethonium chloride, 2-butenyl dimethyl ammonium chloride polymer, behenalkonium chloride, cetalkonium chloride, cetarylalkonium bromide, cetylpyridinium chloride, lauralkonium bromide, lauralkonium chloride, lapyrium chloride, lauryl pyridinium chloride, myristalkonium chloride, olealkonium chloride, isostearyl ethyldimonium chloride, benzyltrimethylammonium dichloroiodate, trimethoxy silyl propyl dimethyl octaecyl ammonium chloride or a mixture thereof.

In another embodiment, the cationic surfactant may also be a quaternary ammonium compound.

In a further embodiment, the cationic surfactant is an alkylammonium halogenide compound (e.g. an alkylammonium chloride or an alkylammonium bromide). Such compound includes, but is not limited to (2-(4-acetylamino-benzenesulfonylamino-et)-dimethyl-undecyl-ammonium chloride; (2,6-dihydroxy-hexahydro-furo(3,2-b)furan-3-yl)-trimethyl-ammonium chloride; (2-C₁₋₃-phenylaminomethylene-cyclohex-1-enylmethylene)-phenyl-ammonium chloride; (2-isopropyl-5-methyl-cyclohexyloxycarbonylmethyl)-trimethyl-ammonium chloride; (2-oxo-benzothiazol-3-ylmethyl)-tripopyl-ammonium chloride; (3,4-dichloro-benzyl)-dimethyl-(1-propoxycarbonyl-undecyl)-ammonium chloride; (3-dimethylamino-2-phenyl-allylidene)-dimethyl-ammonium chloride (1); 4-(4,6-diamino-M-tolyl)imino-2,5-cyclohexadien-1-ylidene)di-me ammonium chloride; (4-allyl-2-methoxy-phenoxycarbonylmethyl)-triethyl-ammonium chloride; adamantan-1-yl-decycloxycarbonylmethyl-dimethyl-ammonium chloride; allyloxycarbonylmethyl-trimethyl-ammonium chloride; benzyl-(1-ethoxycarbonyl-undecyl)-dimethyl-ammonium chloride; benzyl-(1-hexyloxycarbonyl-undecyl)-dimethyl-ammonium chloride; benzyl-(1-methoxycarbonyl-undecyl)-dimethyl-ammonium chloride; benzyl-(2-(2-bromo-3-methyl-butyryloxy)-theyl)-methyl-ammonium chloride; benzylbis(2-hydroxymethyl)(2-dodecyloxyethyl) ammonium chloride; benzyldimethyl(2-dodecycloxyethyl)-ammonium chloride; benzyldimethyl(2-hydroxyethyl)ammonium chloride; benzyldimethyl (hexadecylcarbamoylmethyl)ammonium chloride; benzyldimethyl(tetradecylcarboamoylmethyl)ammonium chloride; benzyloxycarbonylmethyl-trimethyl-ammonium chloride; bis-(2-hydroxyethyl)-cinnamyl(2-dodecyloxyethyl)ammonium chloride; bis(triphenylphosphoranylidene)ammonium chloride; carboxymethyl-dimethyl-ammonium chloride; dimethyldodecyl(5,6,7,8-tetrahydro-2-naphthylmethyl)ammonium chloride; dimethyloctadecyl[3-(trimethoxysilyl)propyl]ammonium chloride; dodecyl-dimethyl-(3-phenyl-allyloxycarbonylmethyl)-ammonium chloride; tetrakis(2-chloroetyl)ammonium chloride; tributyl-(2-hydroxy-3-(2-oxo-benzothiazol-3-yl)-propyl)-ammonium chloride; triethyl-(2-hydroxy-3-(2-oxo-benzothiazol-3-yl)-propyl)-ammonium chloride; trimethyl-(2-oxo-benzothiazol-3-ylmethyl)-ammonium chloride; trimethyl-vinyloxycarbonylmethyl-ammonium chloride; trioctyl-(2-oxo-benzothiazol-3-ylmethyl)-ammonium chloride and/or tris-(2-hydroxy-ethyl)-(2-oxo-benzothiazol-3-ylmethyl)-ammonium chloride.

In another embodiment, the cationic surfactant may be an alkylphosphonium halogenide compound (e.g. an alkylphosphonium chloride or an alkylphosphonium bromide). Such compound includes, but is not limited to 1-(1H-benzoimidazol-2-yl)-2-di-ME-amino-vinyl)-triphenyl-phosphonium chloride; (1,3-dioxo-1,3-dihydro-isoindol-2-ylmethyl)-triphenyl-phosphonium chloride; (1-(3-tert-butyl-ureido)-2,2-dichloro-vinyl)-triphenyl-phosphonium chloride; (1-(4-bromo-benzoylamino)-2,2-dichloro-vinyl)-triphenyl-phosphonium chloride; (1-acetylamino-2,2-dichloro-vinyl)-triphenyl-phosphonium chloride, (1-acetylamino-2-chloro-2-methylsulfanyl-vinyl)-triphenyl-phosphonium chloride (1), (1-acetylamino-2-cl-2-(4-cl-phenylsulfanyl)-vinyl)-tri-ph-phosphonium chloride; (1-acetylamino-2-oxo-2-phenyl-ethyl)-triphenyl-phosphonium chloride; (1-benzoylamino-2,2-bis-ethylsulfanyl-vinyl)-triphenyl-phosphonium chloride; (1-(benzoylamino)-2,2-bis(methylthio)vinyl)(triphenyl) phosphonium chloride; (1-benzoylamino-2,2-bis-phenylsulfanyl-vinyl)-triphenyl-phosphonium chloride; (1-benzoylamino-2,2-dichloro-vinyl)-triphenyl-phosphonium chloride; (1-benzoylamino-2-(4-chloro-phenyl)-vinyl)-triphenyl-phosphonium chloride; (1-benzoylamino-2-(4-cl-phenylsulfanyl)-vinyl)-triphenyl-phosphonium chloride; (1-benzoylamino-2-(4-nitro-phenyl)-vinyl)-triphenyl-phosphonium chloride; (1-benzoylamino-2-chloro-vinyl)-triphenyl-phosphonium chloride; (1-(benzoylamino)-2-cl-2-((4-cl-phenyl)thio)vinyl)(triphenyl) phosphonium chloride; (1-(benzoylamino)-2-cl-2-(4-fluorophenyl)vinyl)(triphenyl) phosphonium chloride; (1-benzoylamino-2-cl-2-P-tolylsulfanyl-vinyl)-triphenyl-phosphonium chloride; (1-(benzoylamino)-2-hydrazinovinyl)(triphenyl) phosphonium chloride; (1-benzoylamino-2-phenyl-vinyl)-triphenyl-phosphonium chloride; (1-benzoylamino-2-phenylsulfanyl-vinyl)-triphenyl-phosphonium chloride; 1-ethoxyyl-5,5-diphenyl-pyrazol-3-yl-triphenyl-phosphonium chloride; (1H-benzoimidazol-2-ylmethyl)-triphenyl-phosphonium chloride; (2,2-dl-cl-1-((2,4-dichlorobenzoyl)amino)vinyl)(triphenyl) phosphonium chloride; (2,2-dichloro-1-(2-chloro-acetylamino)-vinyl)-triphenyl-phosphonium chloride; (2,2-dichloro-1-(2-fluoro-acetylamino)-vinyl)-triphenyl-phosphonium chloride; (2,2-dichloro-1-(3,3-dimethyl-ureido)-vinyl)-triphenyl-phosphonium chloride; (2,2-dichloro-1-(3-phenyl-ureido)-vinyl)-triphenyl-phosphonium chloride; (2,2-dichloro-1-((4-chlorobenzoyl)amino)vinyl)(triphenyl)phosphonium chloride; (2,2-dichloro-1-(4-fluoro-benzoylamino)-vinyl)-triphenyl-phosphonium chloride; (2,2-dichloro-1-(4-methoxy-benzoylamino)-vinyl)-triphenyl-phosphonium chloride; (2,2-dichloro-1-(4-methyl-benzoylamino)-vinyl)-triphenyl-phosphonium chloride; (2,2-dichloro-1-ethoxycarbonylamino-vinyl)-triphenyl-phosphonium chloride; 2,2-dichloro-1-methoxycarbonylamino-vinyl)-triphenyl-phosphonium chloride; (2,2-dichloro-1-phenylacetylamino-vinyl)-triphenyl-phosphonium chloride; ((2,2-dimethyl-propionylamino)-methyl)-triphenyl-phosphonium chloride; (2-(4-cl-ph)-1-(5-phenyl-tetrazol-1-yl)-vinyl)-triphenyl-phosphonium chloride; (2-adamantan-1-yl-2-methoxycarbonyl-vinyl)-triphenyl-phosphonium chloride; (2-anilino-5-(4-morpholinyl)-1,3-oxazol-4-yl)(triphenyl)phosphonium chloride; (2-(benzoylamino)-2-carboxy-1-phenylvinyl)(triphenyl)phosphonium chloride; (2-benzoylamino-2-ethoxycarbonyl-1-phenyl-vinyl)-triphenyl-phosphonium chloride; (2-benzoylamino-2-ethoxycarbonyl-vinyl)-triphenyl-phosphonium chloride; (2-benzoylamino-3-oxo-3-piperidin-1-yl-propenyl)-triphenyl-phosphonium chloride; (2-carboxy-1-(4-chloro-benzoyl)-2-oxo-ethyl)-triphenyl-phosphonium chloride; (2-chloro-1-(2,2-dimethyl-propionylamino)-vinyl)-triphenyl-phosphonium chloride; (2-chloro-1-(4-chloro-benzoylamino)-vinyl)-triphenyl-phosphonium chloride; ((2-chloro-acetylamino)-methyl)-triphenyl-phosphonium chloride; (2-ho-3-(2-oxo-1,3-benzothiazol-3(2H)-yl)pr)(tri-ph)phosphonium chloride hydrate; (2-hydroxy-3-(2-oxo-benzothiazol-3-yl)-propyl)-triphenyl-phosphonium chloride; (2-methyl-5-(4-morpholinyl)-1,3-oxazol-4-yl)(triphenyl)phosphonium chloride; (2-methyl-5-(methylthio)-1,3-thiazol-4-yl)(triphenyl)phosphonium chloride; (2-((oxo-1,2-diphenyl-ethylIDENE)-hydrazano)-PR)-triphenyl-phosphonium chloride; (2-oxo-2-phenyl-1-phenylacetylamino-ethyl)-triphenyl-phosphonium chloride; (2-oxo-benzothiazol-3-ylmethyl)-triphenyl-phosphonium chloride; (3-benzyloxy-4-methoxy-benzyl)-triphenyl-phosphonium chloride; (3-carboxy-propyl)-methyl-diphenyl-phosphonium chloride; (3-carboxy-propyl)-triphenyl-phosphonium chloride; (3-mercapto-1-ph-pyrimido(1,6-a)benzimidazol-4-yl)(tri-ph)phosphonium chloride; ((4-chloro-benzoylamino)-methyl)-triphenyl-phosphonium chloride; (((4-chlorobenzoyl)amino)methyl)(triS(ethylamino)) phosphonium chloride (1), (4-mercapto-6-oxo-2-P-tolyl-2H-pyrimidin-5-yl)-triphenyl-phosphonium chloride; (4-methoxy-3,6-dioxo-cyclohexa-1,4-dienylmethyl)-triphenyl-phosphonium chloride; (5-amino-pyrazolo(1,5-a)pyrimidin-3-yl)-triphenyl-phosphonium chloride; (5-anilino-2-phenyl-1,3-oxazol-4-yl)(triphenyl)phosphonium chloride; (5-(benzoyl-phenyl-amino)-2-phenyl-oxazol-4-yl)-triphenyl-phosphonium chloride; (5-(benzylthio)-2-phenyl-1,3-thiazol-4-yl)(triphenyl)phosphonium chloride; (5-cyanomethylsulfanyl-2-ph-1H-imidazol-4-yl)-triphenyl-phosphonium chloride; (5-(methylamino)-2-phenyl-1,3-oxazol-4-yl)(triphenyl)phosphonium chloride; (5-methylsulfanyl-2-phenyl-1H-imidazol-4-yl)-triphenyl-phosphonium chloride; (6-(2-(chloro-me-ph)-vinyl)-PYRIdiN-2-ylmethyl)-triphenyl-phosphonium chloride; (((adamantan-1-carbonyl)-amino)-methyl)-triphenyl-phosphonium chloride; allyl-triphenyl-phosphonium chloride; benzyl-carboxymethyl-diphenyl-phosphonium chloride; benzyl-methyl-diphenyl-phosphonium chloride; bis-(2-cyano-ethyl)-methyl-naphthalen-1-ylmethyl-phosphonium chloride; (chloromethyl)(triphenyl)phosphonium chloride; (cl-1-(4-cl-benzoylamino)-2-ethylsulfanyl-vinyl)-triphenyl-phosphonium chloride; (eto-carbonyl-4,4-di-me-5,5-diphenyl-pyrazol-yl)-triphenyl-phosphonium chloride; phenanthren-9-ylmethyl-triphenyl-phosphonium chloride; tetrakis[tris(dimethylamino) phosphoranylidenamino]phosphonium chloride; triphenyl-((2,2,2-trichloro-acetylamino)-methyl)-phosphonium chloride; triphenyl-((2,2,2-trifluoro-acetylamino)-methyl)-phosphonium chloride; triphenyl-(2-phenyl-5-P-tolylamino-oxazol-4-yl)-phosphonium chloride; triphenyl(2-pyridylmethyl)phosphonium chloride hydrochloride; triphenyl-(3,4,5-trimethoxy-benzyl)-phosphonium chloride and/or triphenyl(3-PYRIdiNylmethyl)phosphonium chloride.

In an aspect, the present solution can be added to water-based or oil-based paints (e.g. domestic, commercial or industrial paints). The addition of the solution to the paints prevents or delays the growth of microorganisms, thereby augmenting the shelf-life of the paints or varying the uses of the paints.

The solution described herein can also be used in the pure concentrated or diluted form in whirlpool, spa and pool in replacement of chlorine, bromide, ozone, etc. In this particular embodiment, the solutions can be used in an undiluted or a diluted form. The solutions described herein are convenient to keep whirlpools, pools and spas clean, clear and easy to maintain. In addition, the antimicrobial solution can be used advantageously to prevent recurring odour, eye irritation, microbial growth (such as algae growth), corrosion and scaling problems.

The solutions described herein can also be used as cleaning products, disinfectants or antimicrobial products in the health (hospitals, clinics, etc.), industrial (e.g. food industry, clothing industry, pharmaceutical industry), commercial and domestic sectors. The solutions can also be used to clean, disinfect or reduce the microbial load in floors (such as rugs), on instruments (such as medical instruments), on the human or animal skin, on various surfaces (such as hard surfaces), in vehicles (such as cars, busses, trucks or ambulances), in bathrooms and toilets, in floor waxes and shampoos, in etching solutions, in deodorants (animal or human), in dishes and in laundry products.

In another aspect, the present invention also provides a substrate comprising the solution described herein as well as methods of producing such substrate. As used herein, the term “substrate” refers to a substance acted upon by the solution. In an embodiment, the substrate may be solid (such as a fabric) or semi-solid (such as a gel). The solution may be applied directly to the substrate or the fibres that are used to make up the substrate. The substrate may be sprayed with the solutions or may be dipped in the solutions. In another embodiment, the substrate treated with the solutions described herein may be used into a dry and/or a humid environment.

In an embodiment, the solutions, once applied to the substrate, do not stain or discolour the substrate. The solutions may be applied before, simultaneously or after a finishing operation. In another embodiment, the compositions described herein do not alter the properties (such as the color and the durability) of the finishing operation.

In yet another embodiment, the solutions described herein could also be used in substrate finishing. The term “substrate finishing” includes, but is not limited to bleaching, dyeing, printing (e.g. rolling, screen, flock, plisse), stonewashing, mechanical finishing (such as preshrinking, shrinking, sponging, calendaring, mercerizing, and napping), cleaning, scouring, and preparing natural fibres and raw stock. As used herein, the terms “substrate finishing” or “finishing operation” refer to the application of finished to a substrate to confer additional surface properties. These additional surface properties include, but are not limited to, antimicrobial activity, water and oil repellency, stain protection, water resistance, oil resistance, wetability, absorption capacity, adsorption capacity, fire retardantcy, flame resistance, static dissipation, heat dissipation and/or electrical conductivity. As such, the solutions can be used to prepare coating formulations for substrates such as textile fabrics, papers, filtration materials, woven and non-woven materials, membranes, and composites. The solutions may be used in a non-diluted form or diluted with other solutions used in substrate finishing. The substrate treated with the solutions can also be calendared.

In yet another embodiment, the solutions described herein can be particularly useful in domestic and industrial laundering. The solutions may be applied to the substrate before, during or after domestic and industrial laundering. The solutions may be used either in pure or diluted liquid forms. The solutions may also be diluted with a product already used in domestic and industrial laundering. For example, the solutions may be used during the washing cycle, the after-wash cycle, the rinsing cycle, the drying cycle and/or afterward. In an another embodiment, the solutions are used preferably during the rinsing cycle, the drying cycle and/or afterwards. The solutions may be used in the presence of a detergent or a rinsing agent. The solutions may also be used in the form of a spray. The spray may be applied on the substrate before or after the washing and/or drying cycle.

In an embodiment, the substrate subjected to the solutions described herein could also be ironed or heat-pressed without observing a decrease in the antimicrobial activity of the composition.

In another embodiment, the present invention also encompasses using the solutions in a wet-spinning process to obtain wet-spun fibres. The polymer-forming materials of the fibres include, but are not limited to, cellulosics (viscose, rayon, acetate), acrylics, polyesters, polyamides, polyvinylalcohols, or a combination thereof. In this particular embodiment, the composition is embedded in the final product (e.g. wet-spun fibres).

In a further embodiment, the solutions can provide a sanitizing effect to the substrate. As used herein, “sanitization” refers to the positive effects obtained by the inhibition or reduction of microbial activity on a substrate such as a fabric. These positive effects may include, but are not limited to the prevention of malodour development (such as the one generally caused by microbial growth) and the prevention of microbial growth. For example, the solution may provide prevention of malodour development on stored and worn fabrics. In addition, the solution may inhibit or at least reduce the bacterial and/or fungal development on moist substrate (such as moist fabrics).

According to another aspect, the present invention also provides methods of producing the solutions described herein. Various embodiments of the solutions have been described herein. The methods described herein prevent or delay the coagulation and/or prevent or delay flocculation of the particles.

In an embodiment, such method comprises combining a soluble metallic salt (such as a silver, copper, gold salt or combination thereof) with a surfactant. For those skilled in the art, the solubility of a compound is established on a relative scale. In an embodiment, the solubility of a metallic salt is related to its K_{SP} value (Handbook of Chemistry and Physics, CRC Press, 80th Ed., 1999, Sections 4 and 8). In general, the solubility of a metallic salt is proportional to its K_{SP} value, e.g. the more soluble, the higher the K_{SP} value and vice versa. As used herein, the term “soluble” refers to metallic salts having a K_{SP} value above 1×10⁻⁴. For example, the K_{SP} value of the soluble silver acetate salt is 1.94×10⁻³. For some very soluble metallic salt, the K_{SP} value cannot be found. An example of a very soluble metallic salt which does not have a pre-determined K_{SP} value is silver nitrate. As used herein, the term “soluble metallic salt” includes soluble metallic salt and very soluble metallic salt. Soluble metallic salt includes, but is not limited to soluble cooper salts, soluble silver salts, soluble gold salts or a combination thereof. In another embodiment, the soluble copper salts include, but are not limited to, copper (II) nitrate, copper (II) acetate monohydrate, copper (II) chloride, copper (II) bromide, copper (II) chlorate hexahydrate, copper (II) formate, copper (II) butanoate monohydrate, copper (II) sulphate, copper (II) perchlorate, copper (II) hexafluorosilicate or a mixture thereof. Soluble silver salts include, but are not limited to, silver (I) nitrate, silver (I) acetate, silver (I) chlorate, silver (I) fluoride, silver (I) perchlorate, and mixtures thereof. Soluble gold salts may be, for example, gold (III) fluoride, gold (III) chloride and gold (III) bromide or a mixture thereof.

Surprisingly, the combination of the soluble metallic salt with the surfactant enables the formation of particles comprising a slightly soluble metallic salt and the surfactant. More specifically, and without wishing to be bound to any specific theory, the following reaction occurs in the methods described herein:

M^{+,++,+++}(X⁻)ₐ+SC⁺Y⁻→M^{+,++,+++}(Y⁻)_{b}+SC⁺+X⁻
wherein M^{+,++,+++} is a metallic ion (e.g. copper, silver and/or gold ion);
   X⁻ is an anion (e.g. that can be combined with a metal);
   M^{+,++,+++}(X⁻)ₐ is a soluble metallic salt;
   SC⁺ is a cationic surfactant;
   Y⁻ is an anion (e.g. that can be combined with a surfactant);
   M^{+,++,+++}(Y⁻)_{b} is a slightly soluble metallic salt.

In an embodiment, the solution obtained by the methods described herein can also contain additional soluble metallic salt, additional slightly soluble metallic salt, additional surfactant, etc.

The methods for producing the solutions can be used for producing stable solutions having an otherwise slightly soluble metallic salt. Without wishing to be bound to any specific theory, the presence of a molar excess of the surfactant in the solutions enables the surfactant to surround the slightly soluble metallic salt and therefore inhibits or delays the coagulation and/or flocculation of the particles. In the Examples provided below, a solution having a slightly soluble metallic salt wherein the solution possesses enhanced stability and redispersability is described.

Various embodiments of the slightly soluble metallic salt, the surfactant and the particles that can be used in the present methods have been described herein.

In an embodiment, a solution of surfactant is prepared by dissolving a solid amount of the surfactant in water or by diluting a concentrated surfactant solution in water. In another embodiment, a solution of a soluble metallic salt solution is prepared by dissolving a solid amount of the soluble metallic salt in water or by diluting a concentrated soluble metallic salt solution in water. In another embodiment, the soluble metallic salt solution and the surfactant solution are combined with one another. In an embodiment, the solution obtained with this method comprise particles.

In another embodiment, the solutions obtained with this method comprises colloidal slightly soluble metallic salt. In yet another embodiment, ultrasonic vibrations may be used to reduce the average particle size. In another embodiment, the method may also comprises combining a further agent (such as a further slightly soluble metallic salt, a soluble metallic salt or a surfactant) with the solution obtained previously. Various embodiments of the further agent (e.g. a soluble metallic salt and/or a further surfactant) have been described above.

According to another aspect, the invention also provides solutions prepared by the above-mentioned methods.

According to yet another aspect, the invention also provides uses of the solutions described herein for substrate finishing and/or substrate sanitizing.

The present invention will be more readily understood by referring to the following examples which are given to illustrate the invention rather than to limit its scope.

### Example I

### Assessment of the Stability and Redispersability of Compositions Prepared with Various Chemicals

Silver chloride (AgCl) solutions were prepared by various methods using combination of different chemicals. In the present Example, the influence of different chemicals on the solution stability and redispersability of a silver chloride solution were evaluated. Three different chemicals were used: silver nitrate (AgNO₃), sodium chloride (NaCl) and benzalkonium chloride (BC).

Three different methods were used to prepare 1 liter of 0.04 M AgCl solution. Solution 1 was prepared by mixing 0.04 mol AgNO₃ and 0.05 mol NaCl. Solution 2 was prepared by mixing 0.04 mol AgNO₃, 0.05 mol benzalkonium chloride and 0.05 mol NaCl. Solution 3 was prepared by mixing 0.04 mol AgNO₃ and 0.05 mol benzalkonium chloride. Once the solutions were prepared, their stability and redispersability were assessed visually for 65 hours. The assessment of the stability and of the redispersability for these three AgCl solutions is presented in the Table 1.

The results presented in Table 1 indicate that solution 1 was not stable after 3 hours; AgCl crystal deposition was observed and redispersability was not possible. On the other hand, solution 2 was stable for the first 7 hours but not after 21 hours. More specifically, after 21 hours, deposition of the crystals was observed in solution 2, but it was still possible to redisperse the deposited AgCl crystals. However, the redispersability of solution 2 was not possible after 65 h. Solution 3 was stable for more than 65 hours, without any AgCl crystal deposition.

TABLE 1
Stability and redispersability of three 0.04 M AgCl solutions
prepared as described in Example 1.

| Time | Solution 1 | | Solution 2 | | Solution 3 | |
|---|---|---|---|---|---|---|
| [h] | Stability | Redispersability | Stability | Redispersability | Stability | Redispersability |
| 0 | Stable | | Stable | | Stable | |
| 1 | Stable | | Stable | | Stable | |
| 2 | Stable | | Stable | | Stable | |
| 3 | Deposition | Not possible | Stable | | Stable | |
| 4 | | | Stable | | Stable | |
| 5 | | | Stable | | Stable | |
| 6 | | | Stable | | Stable | |
| 7 | | | Stable | | Stable | |
| 21 | | | Deposition | Possible | Stable | |
| 29 | | | Deposition | Possible | Stable | |
| 43 | | | Deposition | Possible | Stable | |
| 51 | | | Deposition | Possible | Stable | |
| 65 | | | Deposition | Not possible | Stable | |

### Example II

### Assessment of the Stability and Redispersability of Compositions Having Varying Concentrations of AgCl

Using the chemicals and methods for producing solution 3 (referred to in Example I), solutions having different concentrations of AgCl were prepared and stability and redispersability were evaluated visually for 65 hours. Table 2 presents the results obtained. For each AgCl concentration composition, 1 liter of solution was prepared.

TABLE 2
Stability and redispersability of different concentrations of AgCl solutions.

| | | | | | | | |
|---|---|---|---|---|---|---|---|
| AgNO₃ (g) | 3.4 | 6.8 | 13.6 | 20.4 | 27.2 | 34 | 68 |
| BC (g) | 10.6 | 21.2 | 42.4 | 63.6 | 84.8 | 106 | 212 |
| [Ag Cl], mol/L | 0.02 | 0.04 | 0.08 | 0.12 | 0.16 | 0.2 | 0.4 |
| Stability | Stable | Stable | Deposition, | Deposition, | Unstable | Unstable | Unstable |
| | | | 2 hours | 2 hours | | | |
| Redispersability | N/A | N/A | Possible | Not | Not | Not | Not |
| | | | | possible | possible | possible | possible |

The results presented in Table 2 indicate that compositions comprising an AgCl concentration of approximately 0.04 mol/L or lower are stable. For solutions comprising an AgCl concentration of approximately 0.08 mol/L and 0.12 mol/L, the composition was stable for the first two hours and redispersability of the crystals was only observed for solutions having an AgCl concentration of approximately 0.08 mol/L.

### Example III

### Assessment of Antibacterial Activity of the Compositions when Coated on a Substrate

An AgCl solution of 0.04 mol/L was prepared according to the method described in Example 2. The solution was then applied as a coating to a woven poly/cotton fabric. Fabric samples were dip coated for one minute into a bath containing the AgCl solution at room temperature. Samples were then dried at 180° C. for 3 minutes. Control samples were dip coated for one minute into a control water bath at room temperature. Control samples were dried at 180° C. for 3 minutes. The samples were tested for antibacterial activity using AATCC 147 Parallel Streak Standard Method. This method is a semi-quantitative method which evaluates antibacterial activity of diffusible antimicrobial agents on treated fabrics (AATCC Test Method 147-1998, Antibacterial Activity Assessment of Textile Materials: Parallel Streak Method; in: AATCC Technical Manual, 280-281, 2001). The method evaluates the ability of a fabric to allow or restrict the growth of bacteria and to assess, in a semi-quantitative manner, the antibacterial activity of the treated fabric (measurement of the zone of inhibition). Test results for different bacteria (gram positive and gram negative bacteria), for fabric treated with the AgCl solution (coated) and a control fabric (control), are presented at Table 3.

TABLE 3
AATCC 147 test results against different bacteria for non-treated
(control) and AgCl coated fabric (coated) samples.

| | Growth under the | | | |
|---|---|---|---|---|
| | specimen, presence | | Zone of inhibition | |
| | (P) or absence (A) | | (mm) | |
| | Control | Coated | Control | Coated |
| Staphylococcus aureus | P | A | 0 | 9 |
| Bacillus cereus | P | A | 0 | 8 |
| Escherichia coli | P | A | 0 | 5 |
| Shigella sp. | P | A | 0 | 8 |
| Salmonella sp. | P | A | 0 | 4 |
| Listeria monocytogenes | P | A | 0 | 11 |

For the control fabric, all the bacteria tested were able to grow whereas no bacterial growth was detected for the AgCl coated fabric. In addition, the zone of inhibition for the control sample was 0 mm, in comparison to several millimetres for the AgCl coated fabric.

### Example IV

### Assessment of Antibacterial Activity of the Compositions on Resin-Coated/Heat-Treated Substrates

An AgCl solution of 0.04 mol/L was prepared according to the method described in Example 2. The solution was then applied as a coating to a woven nylon fabric. Fabric samples were dip coated for one minute into a bath, maintained at room temperature, containing the colloidal AgCl solution and a polymer resin (polyvinyl alcohol, PVA) as a binder to obtain a resin-coated fabric. Samples were dried at 180° C. for 3 min. Treated nylon fabric thus had on its surface antimicrobial AgCl nanocrystals embedded into a thin polymer coating. Control samples were dip coated one minute into a bath, maintained at room temperature, containing a polymer resin (polyvinyl alcohol, PVA) as a binder to obtain a resin-coated fabric. Control samples were then dried at 180° C. for 3 min.

Some treated and control samples were further sterilized using an autoclave (15 min, at 121° C. and 15 psi). The autoclaved samples are further referred to as sterile fabrics.

Samples were tested for antibacterial activity using the AATCC 147 Parallel Streak Standard Method. Table 4 presents AATCC 147 test result against Staphylococcus aureus (gram positive) and Escherichia coli (gram negative) bacteria for non-treated (control) and AgCl/PVA coated fabric samples as well as for non-sterile and sterile fabrics.

TABLE 4
AATCC 147 test results against S. aureus and E. coli for control and
AgCl/PVA coated fabric samples.

| | |
|---|---|
| E. coli | S. aureus |

| | | | | |
|---|---|---|---|---|
| | Non- | | Non- | |
| Fabric | sterile | Sterile | sterile | Sterile |

Growth under the specimen,
presence (P) or absence (A)

| | | | | |
|---|---|---|---|---|
| Control | P | P | P | P |
| AgCl/PVA | A | A | A | A |

Zone of inhibition (mm)

| | | | | |
|---|---|---|---|---|
| Control | 0 | 0 | 0 | 0 |
| AgCl/PVA | 2.2 | 2.0 | 3.0 | 2.0 |

For the control fabric, growth of E. coli and S. aureus was observed under the specimen whereas no growth of the bacteria was observed for the fabric treated with the AgCl solution. The zone of inhibition for the control sample was 0 mm, in comparison to 2-3 mm for the AgCl/PVA coated fabric. The results presented herein indicate that AgCl/PVA coated fabric maintained a high level of performance even after autoclaving (sterile specimen).

### Example V

### Assessment of Antibacterial Activity of the Compositions when Coated on a Substrate

An AgCl solution of 0.04 mol/L was prepared according to the method described in Example 2. The solution was then applied as a coating to a woven poly/cotton fabric. Fabric samples were dip coated for one minute into a bath containing the AgCl solution at room temperature. Samples were then dried at 180° C. for 3 minutes. Control samples were dip coated for one minute into a control water bath at room temperature. Control samples were dried at 180° C. for 3 minutes. The samples were tested for antibacterial activity using AATCC 100 Antibacterial Finishes on Textile Materials. This method is a quantitative procedure for the evaluation of bactericidal activity on treated fabrics (AATCC Test Method 100-1999, Antibacterial Finishes on Textile Materials: Assessment of; in: AATCC Technical Manual, 149-151, 2001). The method evaluates the ability of a fabric to kill bacteria and to assess, in a quantitative manner, the time required to kill such bacteria. Test results with S. aureus, for fabric treated with the AgCl solution (coated) and a control fabric (control), are presented at Table 5.

TABLE 5
AATCC 100 test results against S. aureus bacteria for non-treated
(control) and AgCl coated fabric (coated) samples.

| | |
|---|---|
| S. Aureus | Bacterial counts |

| Time | | Control | Coated |
|---|---|---|---|
| “0” time (approx. 1 min) | UFC | 4 100 | 0 |
| 30 min | UFC | 3 200 | 0 |
| 1 hour | UFC | 4 300 | 0 |
| 6 hours | UFC | 73 000 | 0 |
| 24 hours | UFC | >560 000 | 0 |
| R Percent reduction, 24 hours | % | 0 | 100 |

The percent reduction, R (%), is calculated from the following formula:

R=100(B−A)/B
Wherein A is the number of bacteria recovered from the inoculated treated test specimen swatches in the jar incubated over the desired contact period; and
   B is the number of bacteria recovered from the inoculated treated test specimen swatches in the jar immediately after inoculation (at “0” contact time).
      For the control fabric, the bacteria tested (S. aureus) was able to grow and divide whereas no bacterial growth was detected for the AgCl coated fabrics. The results presented herein also show that the coated fabric kills the inoculated bacteria since the bacterial counts at any time is 0 UFC (even after inoculation at T₀). The percent reduction of the treated fabric is 100% after 24 hours.

### Example VI

### Assessment of Antifungal Activity of the Compositions on Resin-Coated/Heat-Treated Substrates

An AgCl solution of 0.04 mol/L was prepared according to the method described in Example 2. The solution was then applied as a coating to a woven polycotton fabric. Fabric samples were dip coated for one minute into a bath, maintained at room temperature, containing the colloidal AgCl solution and a polymer resin (polyvinyl acetate, PVAc) and a cross-linker to obtain a resin-coated fabric. Samples were dried and cured at 180° C. for 1 min. Treated polycotton fabric thus had on its surface antimicrobial AgCl nanocrystals embedded into a thin polymer coating. Control samples were dip coated one minute into a bath, maintained at room temperature, containing a cross-linked polymer resin (PVAc) as a binder to obtain a resin-coated fabric. Control samples were then dried and cured at 180° C. for 1 min.

Samples were tested for antifungal activity using the ASTM G21-96 method (Determining Resistance of Synthetic Polymeric Materials to Fungi, Assoc. Standard Testing Material). Table 6 presents ASTM G21-96 test results against a mixed fungal spore inoculum consisting of equal numbers of spores of the following species: Aspergillus niger (ATCC 9642), Chaetomium globosum (ATCC 6205), Penicillium funiculosum (ATCC 11797), Aureobasidium pullulans (ATCC 15233) and Trichoderma virens (ATCC 9645). Both non-treated (control) and AgCl/PVAc coated fabric samples (SC1 and SC2, repetitions) were inoculated and incubated at 28° C. for 28 days, in order to allow fungal growth to appear.

TABLE 6
ASTM G21-96 test results against a mixed fungal spore inoculum for
Control and AgCl/PVAc coated fabric samples (SC1 and SC2).

| Sample | Part of the | Days of incubation | | | |
|---|---|---|---|---|---|
| description | fabric | 7 days | 14 days | 21 days | 28 days |
| Control | Face | 0 | 1 | 1 | 2 |
| | Backing | 0 | 1 | 1 | 2 |
| SC1 | Face | 0 | 0 | 0 | 0 |
| | Backing | 0 | 0 | 0 | 0 |
| SC2 | Face | 0 | 0 | 0 | 0 |
| | Backing | 0 | 0 | 0 | 0 |

Table 6 legend:
0 = specimen remained free of fungal growth;
1 = traces of growth on specimen (less than 10% of coverage of the Petri dish);
2 = light fungal growth on specimen (10 to 30%);
3 = medium fungal growth on specimen (30 to 60%);
4 = heavy fungal growth on specimen (more than 60%).

For the control fabric, traces of growth of fungi was observed on the face and the backing of the specimen after 14 days of incubation. After 28 days, a light fungal growth was observed (10 to 30%). No growth of the fungi was observed for the fabric treated with the AgCl solution even after 28 days of incubation.

### Example VII

### Measurement of Particle Size Range of the Nanoparticles into the Liquid Solution

An AgCl solution of 0.04 mol/L was prepared according to the method described in Example 2. A light diffusion technique, using a 4 mW He—Ne laser at 633 nm and consisting of a Zetasizer Nano ZS™ (manufactured by Malvern) was used to measure the particle size range of the nanoparticles into the liquid solution. The particle size distribution value ranged from 167.0 to 169.8 nm. The zeta potential measurement value ranged from 50.8 to 53.4 mV.

### Example VIII

### Assessment of Antibacterial Activity of AgI Compositions when Coated on a Substrate

A 0.04 M of an AgI solution for a volume of 1 liter was prepared by mixing 0.04 mol AgNO₃ and 0.05 mol benzalkonium iodide. Once the AgI nanocrystals were formed, the solution was applied as a coating to a woven polycotton fabric. Fabric samples were dip coated for one minute into a bath containing the AgI solution at room temperature. Samples were then dried at 180° C. for 3 minutes. Control fabric samples were dip coated for one minute into a control bath maintained at room temperature. Control fabric samples dipped in water and dried at 180° C. for 3 minutes. The samples were tested for antibacterial activity using AATCC 147 and AATCC 100 test methods (as described above in Examples III and V).

Test results with different bacteria (gram positive and gram negative bacteria) and fungi for the fabric treated with the AgI solution (coated) and a control fabric (control) are presented at Table 7. With respect to the AATCC 147 test results, no clear zone of inhibition was obtained for all organisms tested with the control fabric; all the organisms tested were able to grow and the zone of inhibition was 0 mm. For the AgI coated fabric, the width of the zone of inhibition varied from <1 to 8 mm indicating an antimicrobial activity. With respect to the AATCC 100 test results, no reduction of fungi and bacteria growth was observed after 1 min or 1 hour for the control fabric while 100% reduction of microbial growth was obtained after 1 min or 1 hour.

TABLE 7
AATCC 147 and AATCC 100 test results with different bacteria
and fungi for Agl coated fabric (coated) samples.

| | AATCC 147 | | | | | |
|---|---|---|---|---|---|---|
| | Zone of | | AATCC 100 | | | |
| | inhibition (mm) | | Percent reduction (%) | | | |
| | | Treated | Control | | Treated fabric | |
| Organisms | Control | fabric | 1 min | 1 hour | 1 min | 1 hour |
| Fungi | | | | | | |
| Aspergillus Niger | 0 | 7 | 0 | 0 | — | 100 |
| Candida Albicans | 0 | 8 | 0 | 0 | 100 | — |
| Bacteria | | | | | | |
| S. Aureus | 0 | 6 | 0 | 0 | 100 | — |
| B. Cereus | 0 | 6 | 0 | 0 | 100 | — |
| E. Coli | 0 | <1 | 0 | 0 | — | 100 |
| Shigella | 0 | 5 | 0 | 0 | — | 100 |
| Salmonella | 0 | <1 | 0 | 0 | — | 100 |
| Listeria | 0 | 7 | 0 | 0 | 100 | — |
| Monocytogenes | | | | | | |

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential aforementioned features, and as follows in the scope of the appended claims.

1. A solution having an antimicrobial activity, said solution comprising particles having at least one slightly soluble metallic salt and at least one surfactant and wherein the molar ratio between said slightly soluble metallic salt and said surfactant is lower than or equal to about 1.

2. The solution of claim 1, wherein said molar ratio between said slightly soluble metallic salt and said surfactant is lower than or equal to about 0.8 or lower than or equal to about 0.6.

3. (canceled)

4. The solution of claim 1, wherein the average size of said particles is selected from the group consisting of about 10 nm to about 500 nm, about 10 nm to about 150 nm, about 100 nm to about 150 nm, and about 160 nm to about 170 nm.

5-7. (canceled)

8. The solution of claim 1, wherein said antimicrobial activity is against a microorganism selected from the group consisting of a bacterium, a fungus, a mold and a virus.

9. (canceled)

10. The solution of claim 8, wherein said bacterium is selected from the group consisting of Staphylococcus aureus, Bacillus cereus, Escherichia coli, Shigella sp., Salmonella sp., and Listeria monocytogenes and Pseudomonas Aeruginosa.

11. (canceled)

12. The solution of claim 8, wherein said fungus is selected from the group consisting of Aspergillus niger, Chaetomium globosum, Penicillium funiculosum, Aureobasidium pullulans, Trichoderma virens and Candida albicans.

13. The solution of claim 1, wherein the concentration of said slightly soluble metallic salt in said solution is selected from the group consisting of about 4×10⁻⁴M to about 2 M, about 0.02 M to about 0.04 M, and about 0.04 M.

14. (canceled)

15. (canceled)

16. The solution of claim 1, wherein said slightly soluble metallic salt is selected from the group consisting of a slightly soluble copper salt, a slightly soluble silver salt, a slightly soluble gold salt, and a slightly soluble metallic halide.

17. The solution of claim 16, wherein said slightly soluble copper salt is selected from the group consisting of copper (I) chloride, copper (I) bromide, copper (I) iodide, copper (I) fluoride, copper perchlorate, copper (II) iodate, copper sulphate and copper methosulphate.

18. (canceled)

19. The solution of claim 16, wherein said slightly soluble silver salt is selected from the group consisting of silver (I) chloride, silver (I) bromide, silver (I) iodide, silver perchlorate, silver sulphate and silver methosulphate.

20. (canceled)

21. The solution of claim 16, wherein said slightly soluble gold salt is selected from the group consisting of gold (I) chloride, gold (I) bromide, gold (I) iodide, gold perchlorate, gold sulphate and gold methosulphate.

22. (canceled)

23. The solution of claim 16, wherein said slightly soluble metallic halide is silver chloride or silver iodide.

24. (canceled)

25. The solution of claim 1, wherein the concentration of said surfactant in said solution is selected from the group consisting of about 1×10⁻⁴M to about 0.5 M, about 0.025 M to about 0.05 M, and about 0.05 M.

26. (canceled)

27. (canceled)

28. The solution of claim 1, wherein said surfactant is a cationic surfactant.

29. The solution of claim 28, wherein said cationic surfactant is an alkylammonium halogenide.

30. The solution of claim 29, wherein said alkylammonium halogenide is selected from the group consisting of an alkylammonium chloride and an alkylammonium bromide.

31. The solution of claim 29, wherein said alkylammonium halogenide is selected from the group consisting of cetyl trimethyl ammonium bromide, octadecyl dimethyl benzyl ammonium bromide, N-cetyl pyridinium bromide, octylphenoxyethoxy ethyl dimethyl benzyl ammonium chloride, N-(laurylcoco-aminoformylmethyl)pyridinium chloride, lauryloxyphenyl-trimethyl ammonium chloride, dodecylbenzyl trimethyl ammonium chloride, chlorinated dodecylbenzyl trimethyl ammonium chloride, dioctyl dimethyl ammonium chloride, benzalkonium chloride, myristyl dimethylbenzyl ammonium chloride, methyl dodecyl xylene-bis-trimethyl ammonium chloride, benzethonium chloride, 2-butenyl dimethyl ammonium chloride polymer, behenalkonium chloride, cetalkonium chloride, cetarylalkonium bromide, cetylpyridinium chloride, lauralkonium bromide, lauralkonium chloride, lapyrium chloride, lauryl pyridinium chloride, myristalkonium chloride, olealkonium chloride, isostearyl ethyldimonium chloride, benzyltrimethylammonium dichloroiodate, trimethoxy silyl propyl dimethyl octaecyl ammonium chloride, (2-(4-acetylamino-benzenesulfonylamino-et)-dimethyl-undecyl-ammonium chloride; (2,6-dihydroxy-hexahydro-furo(3,2-b)furan-3-yl)-trimethyl-ammonium chloride; (2-cl-3-phenylaminomethylene-cyclohex-1-enylmethylene)-phenyl-ammonium chloride; (2-isopropyl-5-methyl-cyclohexyloxycarbonylmethyl)-trimethyl-ammonium chloride; (2-oxo-benzothiazol-3-ylmethyl)-tripopyl-ammonium chloride; (3,4-dichloro-benzyl)-dimethyl-(1-propoxycarbonyl-undecyl)-ammonium chloride; (3-dimethylamino-2-phenyl-allylidene)-dimethyl-ammonium chloride (1); 4-(4,6-diamino-M-tolyl)imino-2,5-cyclohexadien-1-ylidene)di-me-ammonium chloride; (4-allyl-2-methoxy-phenoxycarbonylmethyl)-triethyl-ammonium chloride; adamantan-1-yl-decycloxycarbonylmethyl-dimethyl-ammonium chloride; allyloxycarbonylmethyl-trimethyl-ammonium chloride; benzyl-(1-ethoxycarbonyl-undecyl)-dimethyl-ammonium chloride; benzyl-(1-hexyloxycarbonyl-undecyl)-dimethyl-ammonium chloride; benzyl-(1-methoxycarbonyl-undecyl)-dimethyl-ammonium chloride; benzyl-(2-(2-bromo-3-methyl-butyryloxy)-theyl)-methyl-ammonium chloride; benzylbis(2-hydroxymethyl)(2-dodecyloxyethyl) ammonium chloride; benzyldimethyl(2-dodecycloxyethyl)-ammonium chloride; benzyldimethyl(2-hydroxyethyl)ammonium chloride; benzyldimethyl(hexadecylcarbamoylmethyl)ammonium chloride; benzyldimethyl(tetradecylcarboamoylmethyl)ammonium chloride; benzyloxycarbonylmethyl-trimethyl-ammonium chloride; bis-(2-hydroxyethyl)-cinnamyl(2-dodecyloxyethyl)ammonium chloride; bis(triphenylphosphoranylidene)ammonium chloride; carboxymethyl-dimethyl-ammonium chloride; dimethyldodecyl(5,6,7,8-tetrahydro-2-naphthylmethyl)ammonium chloride; dimethyloctadecyl[3-(trimethoxysilyl)propyl]ammonium chloride; dodecyl-dimethyl-(3-phenyl-allyloxycarbonylmethyl)-ammonium chloride; tetrakis(2-chloroetyl)ammonium chloride; tributyl-(2-hydroxy-3-(2-oxo-benzothiazol-3-yl)-propyl)-ammonium chloride; triethyl-(2-hydroxy-3-(2-oxo-benzothiazol-3-yl)-propyl)-ammonium chloride; trimethyl-(2-oxo-benzothiazol-3-ylmethyl)-ammonium chloride; trimethyl-vinyloxycarbonylmethyl-ammonium chloride; trioctyl-(2-oxo-benzothiazol-3-ylmethyl)-ammonium chloride and tris-(2-hydroxy-ethyl)-(2-oxo-benzothiazol-3-ylmethyl)-ammonium chloride.

32. (canceled)

33. The solution of claim 1, wherein said surfactant is a quaternary ammonium compound.

34. (canceled)

35. (canceled)

36. The solution of claim 28, wherein said cationic surfactant is an alkylphosphonium halogenide.

37. The solution of claim 36, wherein said alkylphosphonium halogenide is selected from the group consisting of an alkylphosphonium chloride and an alkylphosphonium bromide.

38. (canceled)

39. The solution of claim 37, wherein said alkylylphosphonium chloride is selected from the group consisting of 1-(1 h-benzoimidazol-2-yl)-2-di-me-amino-vinyl)-triphenyl-phosphonium chloride; (1,3-dioxo-1,3-dihydro-isoindol-2-ylmethyl)-triphenyl-phosphonium chloride; (1-(3-tert-butyl-ureido)-2,2-dichloro-vinyl)-triphenyl-phosphonium chloride; (1-(4-bromo-benzoylamino)-2,2-dichloro-vinyl)-triphenyl-phosphonium chloride; (1-acetylamino-2,2-dichloro-vinyl)-triphenyl-phosphonium chloride, (1-acetylamino-2-chloro-2-methylsulfanyl-vinyl)-triphenyl-phosphonium chloride (1), (1-acetylamino-2-cl-2-(4-cl-phenylsulfanyl)-vinyl)-tri-ph-phosphonium chloride; (1-acetylamino-2-oxo-2-phenyl-ethyl)-triphenyl-phosphonium chloride; (1-benzoylamino-2,2-bis-ethylsulfanyl-vinyl)-triphenyl-phosphonium chloride; (1-(benzoylamino)-2,2-bis(methylthio)vinyl)(triphenyl)phosphonium chloride; (1-benzoylamino-2,2-bis-phenylsulfanyl-vinyl)-triphenyl-phosphonium chloride; (1-benzoylamino-2,2-dichloro-vinyl)-triphenyl-phosphonium chloride; (1-benzoylamino-2-(4-chloro-phenyl)-vinyl)-triphenyl-phosphonium chloride; (1-benzoylamino-2-(4-cl-phenylsulfanyl)-vinyl)-triphenyl-phosphonium chloride; (1-benzoylamino-2-(4-nitro-phenyl)-vinyl)-triphenyl-phosphonium chloride; (1-benzoylamino-2-chloro-vinyl)-triphenyl-phosphonium chloride; (1-(benzoylamino) 2-cl-2-((4-cl-phenyl)thio)vinyl) (triphenyl)phosphonium chloride; (1-(benzoylamino)-2-cl-2-(4-fluorophenyl)vinyl)(triphenyl)phosphonium chloride; (1-benzoylamino-2-cl-2-P-tolylsulfanyl-vinyl)-triphenyl-phosphonium chloride; (1-(benzoylamino)-2-hydrazinovinyl)(triphenyl)phosphonium chloride; (1-benzoylamino-2-phenyl-vinyl)-triphenyl-phosphonium chloride; (1-benzoylamino-2-phenylsulfanyl-vinyl)-triphenyl-phosphonium chloride; 1-ethoxyyl-5,5-dIphenyl-pyrazol-3-yl-triphenyl-phosphonium chloride; (1H-benzoimidazol-2-ylmethyl)-triphenyl-phosphonium chloride; (2,2-dI-cl-1-((2,4-dichlorobenzoyl)amino)vinyl)(triphenyl)phosphonium chloride; (2,2-dichloro-1-(2-chloro-acetylamino)-vinyl)-triphenyl-phosphonium chloride; (2,2-dichloro-1-(2-fluoro-acetylamino)-vinyl)-triphenyl-phosphonium chloride;(2,2-dichloro-1-(3,3-dImethyl-ureido)-vinyl)-triphenyl-phosphonium chloride; (2,2-dichloro-1-(3-phenyl-ureido)-vinyl)-triphenyl-phosphonium chloride; (2,2-dichloro-1-((4-chlorobenzoyl)amino)vinyl)(triphenyl) phosphonium chloride; (2,2-dichloro-1-(4-fluoro-benzoylamino)-vinyl)-triphenyl-phosphonium chloride; (2,2-dichloro-1-(4-methoxy-benzoylamino)-vinyl)-triphenyl-phosphonium chloride; (2,2-dichloro-1-(4-methyl-benzoylamino)-vinyl)-triphenyl-phosphonium chloride; (2,2-dichloro-1-ethoxycarbonylamino-vinyl)-triphenyl-phosphonium chloride; 2,2-dichloro-1-methoxycarbonylamino-vinyl)-triphenyl-phosphonium chloride; (2,2-dichloro-1-phenylacetylamino-vinyl)-triphenyl-phosphonium chloride; ((2,2-dImethyl-propionylamino)-methyl)-triphenyl-phosphonium chloride; (2-(4-cl-ph)-1-(5-phenyl-tetrazol-1-yl)-vinyl)-triphenyl-phosphonium chloride; (2-adamantan-1-yl-2-methoxycarbonyl-vinyl)-triphenyl-phosphonium chloride; (2-anilino-5-(4-morpholinyl)-1,3-oxazol-4-yl)(triphenyl) phosphonium chloride; (2-(benzoylamino)-2-carboxy-1-phenylvinyl)(triphenyl)phosphonium chloride; (2-benzoylamino-2-ethoxycarbonyl-1-phenyl-vinyl)-triphenyl-phosphonium chloride; (2-benzoylamino-2-ethoxycarbonyl-vinyl)-triphenyl-phosphonium chloride; (2-benzoylamino-3-oxo-3-piperidin-1-yl-propenyl)-triphenyl-phosphonium chloride; (2-carboxy-1-(4-chloro-benzoyl)-2-oxo-ethyl)-triphenyl-phosphonium chloride; (2-chloro-1-(2,2-dimethyl-propionylamino)-vinyl)-triphenyl-phosphonium chloride; (2-chloro-1-(4-chloro-benzoylamino)-vinyl)-triphenyl-phosphonium chloride; ((2-chloro-acetylamino)-methyl)-triphenyl-phosphonium chloride; (2-ho-3-(2-oxo-1,3-benzothiazol-3(2h)-yl)pr)(tri-ph)phosphonium chloride hydrate; (2-hydroxy-3-(2-oxo-benzothiazol-3-yl)-propyl)-triphenyl-phosphonium chloride; (2-methyl-5-(4-morpholinyl)-1,3-oxazol-4-yl)(triphenyl)phosphonium chloride; (2-methyl-5-(methylthio)-1,3-thiazol-4-yl)(triphenyl) phosphonium chloride; (2-((oxo-1,2-diphenyl-ethylIdene)-hydrazano)-pr)-triphenyl-phosphonium chloride; (2-oxo-2-phenyl-1-phenylacetylamino-ethyl)-triphenyl-phosphonium chloride; (2-oxo-benzothiazol-3-ylmethyl)-triphenyl-phosphonium chloride; (3-benzyloxy-4-methoxy-benzyl)-triphenyl-phosphonium chloride; (3-carboxy-propyl)-methyl-diphenyl-phosphonium chloride; (3-carboxy-propyl)-triphenyl-phosphonium chloride; (3-mercapto-1-ph-pyrimido(1,6-a)benzimidazol-4-yl)(tri-ph)phosphonium chloride; ((4-chloro-benzoylamino)-methyl)-triphenyl-phosphonium chloride; (((4-chlorobenzoyl)amino)methyl)(triS(ethylamino)) phosphonium chloride (1), (4-mercapto-6-oxo-2-p-tolyl-2H-pyrimidin-5-yl)-triphenyl-phosphonium chloride; (4-methoxy-3,6-dioxo-cyclohexa-1,4-dienylmethyl)-triphenyl-phosphonium chloride; (5-amino-pyrazolo(1,5-a)pyrimidin-3-yl)-triphenyl-phosphonium chloride; (5-anilino-2-phenyl-1,3-oxazol-4-yl)(triphenyl) phosphonium chloride; (5-(benzoyl-phenyl-amino)-2-phenyl-oxazol-4-yl)-triphenyl-phosphonium chloride; (5-(benzylthio)-2-phenyl-1,3-thiazol-4-yl)(triphenyl)phosphonium chloride; (5-cyanomethylsulfanyl-2-ph-1H-imidazol-4-yl)-triphenyl-phosphonium chloride; (5-(methylamino)-2-phenyl-1,3-oxazol-4-yl)(triphenyl)phosphonium chloride; (5-methylsulfanyl-2-phenyl-1H-imidazol-4-yl)-triphenyl-phosphonium chloride; (6-(2-(chloro-me-ph)-vinyl)-pyridiN-2-ylmethyl)-triphenyl-phosphonium chloride; (((adamantan-1-carbonyl)-amino)-methyl)-triphenyl-phosphonium chloride; allyl-triphenyl-phosphonium chloride; benzyl-carboxymethyl-diphenyl-phosphonium chloride; benzyl-methyl-diphenyl-phosphonium chloride; bis-(2-cyano-ethyl)-methyl-naphthalen-1-ylmethyl-phosphonium chloride; (chloromethyl)(triphenyl)phosphonium chloride; (cl-1-(4-cl-benzoylamino)-2-ethylsulfanyl-vinyl)-triphenyl-phosphonium chloride; (eto-carbonyl-4,4-di-me-5,5-diphenyl-pyrazol-yl)-triphenyl-phosphonium chloride; phenanthren-9-ylmethyl-triphenyl-phosphonium chloride; tetrakis[tris(dimethylamino) phosphoranylidenamino]phosphonium chloride; triphenyl-((2,2,2-trichloro-acetylamino)-methyl)-phosphonium chloride; triphenyl-((2,2,2-trifluoro-acetylamino)-methyl)-phosphonium chloride; triphenyl-(2-phenyl-5-P-tolylamino-oxazol-4-yl)-phosphonium chloride; triphenyl(2-pyridylmethyl)phosphonium chloride hydrochloride; triphenyl-(3,4,5-trimethoxy-benzyl)-phosphonium chloride and triphenyl(3-pyridiNylmethyl) phosphonium chloride.

40. A substrate comprising the solution of claim 1.

41-45. (canceled)

46. A method for producing a solution having an antimicrobial activity, said method comprising combining, in a solution, (i) at least one soluble metallic salt and (ii) at least one surfactant, said solution comprising particles, said particles comprising (a) at least one slightly soluble metallic salt and (b) said surfactant, wherein the molar ratio between said slightly soluble metallic salt and said surfactant is lower than or equal to about 1.

47-95. (canceled)

96. A method for finishing or sanitizing a substrate comprising contacting said substrate with the solution of claim 1.
